(19) United States
(12) Patent Application Publication
(10) Pub. No.: US 2006/0029795 A1
(43) Pub. Date: Feb. 9, 2006

(54) Multi-layer low friction and low wear polymer/polymer composites having compositionally graded interfaces

(75) Inventors: Wallace Gregory Sawyer, Gainesville, FL (US); David Lawrence Burris, Gainesville, FL (US)

Correspondence Address: AKERMAN SENTERFITT, P.O. BOX 3188, WEST PALM BEACH, FL, 33402-3188, US

(73) Assignee: UNIVERSITY OF FLORIDA RESEARCH FOUNDATION, INC., GAINESVILLE, FL (US)

(21) Appl. No.: 11/140,775

(22) Filed: May 31, 2005

Related U.S. Application Data
(63) Continuation-in-part of application No. 10/914,615, filed on Aug. 9, 2004.

(51) Int. Cl. B32B 9/04; B32B 17/10; B32B 27/00

(52) U.S. Cl. 428/339; 428/422; 428/411.1; 427/402

(57) ABSTRACT

A high strength multi-layer polymeric article having a low wear surface includes a base polymer layer, and a polymer composite capping layer disposed on the base polymer layer. The capping layer includes a first polymer including a transfer film forming polymer, and a second polymer different from the first polymer for strengthening this polymer composite mixed with the first polymer. The first polymer provides at least 10 weight % of the composite capping layer. A transition layer composite including the first and second polymer is interposed between the capping layer and the base polymer layer, at least a portion of the transition layer providing a non-constant first or second polymer concentration. A wear rate of the article is <10⁻⁷ mm³/Nm. The first polymer can be PTFE and the second polymer can be a polyaryletherketone (PEEK).

### CROSS-REFERENCE TO RELATED APPLICATIONS

This application is a continuation-in-part (CIP) of application Ser. No. 10/914,615 filed on Aug. 9, 2004 entitled “LOW FRICTION AND LOW WEAR POLYMER/POLYMER COMPOSITES” which is hereby incorporated by reference into the present application in its entirety.

### STATEMENT REGARDING FEDERALLY SPONSORED RESEARCH OR DEVELOPMENT

The United States Government may have certain rights to this invention pursuant to Air Force Office of Scientific Research-Multidisciplinary University Research Initiative URI (AFOSR-MURI) Grant No. FA9550-04-1-0367).

### FIELD OF THE INVENTION

The invention relates to polymer/polymer composites, more specifically to low wear polymer/polymer composites and related articles.

### BACKGROUND OF THE INVENTION

Solid lubrication offers many benefits over conventional oil-based hydrodynamic and boundary lubrication. Solid lubrication systems are generally more compact and less costly than oil lubricated systems since pumps, lines, filters and reservoirs are usually required in oil lubricated systems. Greases can contaminate the product of the system being lubricated, making it undesirable for food processing and both grease and oil outgas in vacuum precluding their use in space applications. One of the primary goals of a solid lubricant is obtaining low friction.

Polytetrafluoroethylene (PTFE) is known by the trade name TEFLON®. PTFE is well known as a low friction material and has thus received much attention for use as a solid lubricant. It also has other desirable properties including, high melting temperature, chemical inertness, biocompatibility, low outgassing and low water absorption. However, PTFE wears much more rapidly than most other polymers preventing its use as a bearing material in many cases.

It is known that copper and graphite greatly improve the life of PTFE when used as fillers. Glass fibers and micron sized ceramics have also been shown to improve wear resistance of PTFE. These fillers are thought to reduce wear because they preferentially support the load. Briscoe et al (Briscoe, B. J., L. H. Yao, et al. (1986). “The Friction and Wear of Poly(Tetrafluoroethylene)-Poly(Etheretherketone) Composites—an Initial Appraisal of the Optimum Composition.” Wear 108(4): 357-374) disclose a PEEK/PTFE polymer/polymer composite, comprising a plurality of discrete PTFE particles in a polyether ether ketone (PEEK) matrix. PEEK has low wear and high friction and PTFE has high wear and low friction. Briscoe et al. found a disproportionate drop in microhardness, compressive strength and Young's modulus of the PEEK matrix with the addition of small amounts of PTFE, indicative of poor adhesion at the particle-matrix interface. The wear rate of the composite was reported to increase linearly from unfilled PEEK to 3 times the wear rate of unfilled PEEK for the 70 wt % PTFE composite. Wear was reported to be accelerated beyond 70 wt % PTFE. Briscoe et al. concluded that the 10 wt % PTFE composite is optimal.

### SUMMARY OF INVENTION

A high strength multi-layer polymeric article having a low wear surface comprises a base polymer layer and a polymer composite capping layer disposed on the base polymer layer. The capping layer composite includes a first polymer comprising a transfer film forming polymer, and a second polymer different from the first polymer for strengthening mixed with the first polymer. The first polymer comprises at least 10 weight % of the capping layer and a wear rate of the article provided by the composite capping layer surface is <10⁻⁷ mm³/Nm. A composite transition region including the first and second polymer is interposed between the capping layer and the base polymer layer. At least a portion of the transition layer provides a non-constant first and/or second polymer concentration. In a preferred embodiment of the invention, at least a portion of the transition layer has a concentration of polymer that is compositionally graded.

As used herein, the phrase “compositionally graded” refers to a concentration vs. distance profile that is substantially monotonic. Monotonic is defined as successive thickness increments of a given layer which either consistently increase or decrease, such as linearly increasing or decreasing, increasing or decreasing in a stair step fashion, or other substantially monotonically increasing or decreasing function, but do not oscillate in relative value.

The second polymer can comprise between 15 wt. % and 90 wt. % of the capping layer composite. In a preferred embodiment, the wear rate of the article is <10⁻⁸ mm³/Nm. The article also provides a COF generally comparable or lower than that of the transfer film forming polymer. The COF of the article is generally less than 0.15, and preferably is less than 0.13, such as 0.12, 0.11 and most preferably less than 0.10. Thus, articles according to the invention combine very low wear with very low friction.

Tribological testing and parameters described and claimed herein are based on the use of a reciprocating tribometer as further described in the Examples. In tests other than environmental tests, pins were ¼ in×¼ in×½ in long with a 250 N normal load. The reciprocation length was 1 in. The resulting pressure was 6.3 MPa. Sliding velocity was 2 in/s.

In certain inventive embodiments, the softening or “melting” points of the first and second polymer are within 40° C., and preferably within 20° C. of one another. In a preferred embodiment, the first polymer is PTFE and the second polymer is a polyaryletherketone (PEEK). PTFE has a reported “melting point” at about 327° C. and PEEK has a reported “melting point” of about 340 to 344° C.

Although a preferred embodiment uses PEEK as the base polymer and a PTFE/PEEK composite for both the capping layer and transition layer, the invention is in no way limited. For example, the base and/or first polymer can be other mechanically strong polymers, such as ultra high molecular weight polyethylene (UHMWPE), defined herein as having an average molecular weight of at least 3 million daltons. The second polymer can be a polyimide, nylon, polycarbonate or acrylonitrile butadiene styrene (ABS).

A method of forming high performance composite materials having low wear surfaces, comprises the step of providing a base polymer layer, disposing a composite transition layer on the base polymer layer, the transition layer including a first polymer comprising a transfer film forming polymer, and a second polymer different from the first polymer for strengthening mixed with the first polymer. At least a portion of the transition layer provides a non-constant first or second polymer concentration. A polymer composite capping layer is disposed on the base polymer layer, the capping layer comprising the first and second polymer, wherein the first polymer comprises at least 10 weight % of the capping layer. The base polymer layer, transition layer, and capping layer are heated to form the article, wherein after the heating a wear rate of the article provide by the capping layer composite is <10⁻⁷ mm³/Nm.

The heating step preferably comprises processes including compression molding or extrusion. The molding or extrusion step can comprise providing a plurality of transfer film forming polymer particles and a plurality of strengthening phase polymer particles. The particles can be applied to the base polymer using separate nozzles for each polymer, where the ratio of polymer deposited is varied, such as in steps, during formation of the transition region. A generally constant composition is typically used to form the low wear capping layer. A single extrusion or molding step is preferably used a temperature at or above the softening point of at least one, and preferably both, the first transfer film forming polymer and the second strengthening phase polymer to allow softening and mobilization of at least one of the plurality of transfer film forming polymer particles and the plurality of strengthening phase polymer particles. Heating is preferably sufficient to allow the transition region to become integrated with the base polymer layer, such as through polymer bonding across the interfaces between the base polymer layer, transition layer and capping layer.

The plurality of transfer film forming polymer particles can average from 1 to 100 μm and the plurality of strengthening phase polymer particles can average from 50 nm to 10 μm.

### BRIEF DESCRIPTION OF THE DRAWINGS

A fuller understanding of the present invention and the features and benefits thereof will be accomplished upon review of the following detailed description together with the accompanying drawings, in which:

FIG. 1 shows an exemplary concentration of film forming polymer vs. depth profile for a high strength multi-layer polymeric article having a low wear surface, according to an embodiment of the invention.

FIG. 2 shows the wear rate (y-axis) of an exemplary PTFE/PEEK composite according to the invention as a function of PEEK wt % (x-axis) as compared a PEEK/PTFE composite according to the process disclosed by Briscoe et al.

FIG. 3 shows results obtained from wear tests for various exemplary PTFE/PEEK compositions according to the invention.

FIG. 4 shows instantaneous friction results for the composites for which wear test data is shown in FIG. 3.

FIG. 5 shows EDS results of pin wear surface tests from a PEEK/PTFE composite according to the invention demonstrating the material is highly non-abrasive.

FIG. 6(a) is a scanned SEM image and (b) a scanned fluorine map of a PTFE/PEEK composite according to the invention. The light portions in each are PTFE regions.

FIG. 7 shows friction coefficient vs. sliding distance results for a PEEK/PTFE composite according to the invention having 20 wt. % PEEK (balance PTFE) showing environmental insensitivity.

FIG. 8 shows positional data from FIG. 7 demonstrating repeatability of the friction coefficient.

FIG. 9 shows a scanned optical micrograph image of a high strength multi-layer polymeric article having a low wear surface and a graded interface transitional region disposed on top of a component, according to an embodiment of the invention.

### DETAILED DESCRIPTION

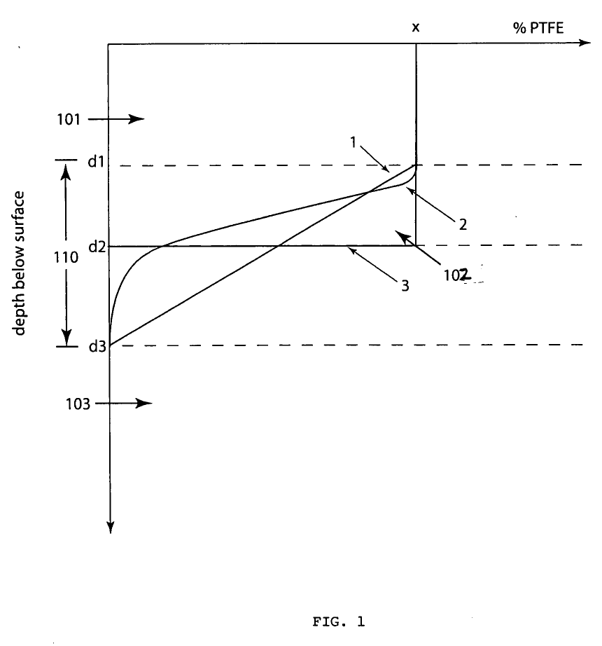

Referring to FIG. 1, a concentration of film forming polymer (shown as PTFE) vs. depth from the surface of a high strength multi-layer polymeric article having a low wear surface, according to an embodiment of the invention, is shown in traces 1 and 2. The article includes capping layer 101, transition layer 102 and base polymer layer 103. Both capping layer 101 and transition layer 102 are polymer composite layers, while base polymer 103 can be a single polymer or a polymer composite layer.

Trace 3 shows a conventional concentration step junction at depth d₂ between the respective capping 101 and base 103 layers. No transition layer 102 is provided in such an arrangement.

Capping layer 101 includes a first polymer comprising a transfer film forming polymer shown as PTFE, and a second polymer different from the first polymer for strengthening the composite mixed with the first polymer, such as PEEK. The first polymer comprises at least 10 weight % of the capping layer composite. The wear rate of the article provided by the capping layer surface is <10⁻⁷ mm³/Nm.

As shown in FIG. 1, transition layer 102 is identified as having a thickness 110 extends from a depth d₁ to d₃. A typical thickness of transition layer 102 is from 0.2 to 10 μm. References 1 and 2 show two exemplary graded junction compositionally graded profiles according to the invention. In both cases the concentration of PTFE increases monotonically towards the surface of the article. Thus, at least a portion of the transition layer 102 provides a non-constant first and/or second polymer concentration.

The transition layer 102 and the capping layer 101 preferably both include material comprising the base polymer article, such as PEEK. When placed together and heated to a sufficient temperature, bonding is initiated between the base polymer layer 103, the transition region 102 and the composite capping layer 101. For example, when the base polymer is PEEK, the composite coating becomes integrated with the base polymer article, such as through bonding of the PEEK extending from the base polymer layer 103 through the transition layer 102 to the composite capping layer 101. The gradual composition change provided by the transition region substantially improves bonding of the article. The resulting article thus becomes highly resistant to delamination.

The capping layer 101 also provides a COF for the article generally comparable or lower than that of the film forming first polymer. The COF of the capping layer 101 is generally less than 0.15, and preferably is less than 0.13, such as 0.12, 0.11 and most preferably less than 0.10.

In one embodiment, the composite comprises a PTFE/PEEK composite. Industrially scalable methods for forming the same are also described herein. The composite articles are generally vacuum compatible, inert, biocompatible, low friction, easy to bond to, very low wear, high temperature capable, space compatible and chemically resistant.

Exemplary transfer film forming polymers include PTFE and high molecular weight linear polyethylene. Linear polyethylene is normally produced with molecular weights in the range of 200,000 to 500,000 daltons, but can obtained commercially having average molecular weights of about three to six million daltons, or more (referred to as ultra-high molecular weight polyethylene, or UHMWPE). Other transfer film forming polymers include polyarylenesterketones.

The second polymer is generally a mechanically strong, low wear and high friction polymer. For example, the second polymer can comprise polyimides, nylons, polycarbonates, acrylonitrile, butadiene styrenes (ABS) and PEEK.

Although compositions for the capping layer and transition layer are formed from first polymer comprising a transfer film forming polymer and a second polymer for strengthening the composite, other materials can be included in the capping layer and the transition layer. For example, two or more film forming polymers can be used as well as two or more strengthening phase polymers. Other materials may be added to the capping layer or transition layer to enhance certain properties, including but not limited to graphite, molybdenum disulfide, and carbon nanotubes. Thus, more generally, composite layers according to the invention have as their main components a first polymer comprising a transfer film forming polymer, and a second polymer for strengthening the composite, as well as optional other materials.

Although not need to practice the claimed invention, Applicants, not seeking to be bound to the theory presented, present the following. Regarding exemplary PTFE/PEEK composites, the wear rate measured has been found to be orders of magnitude lower than either PTFE or PEEK, and the COF can be lower than for the low friction transfer film forming polymer material. The origin of the low friction may originate from the transfer film. The transfer film is very thin, uniform and well adhered to the counterface. This is in direct contrast to PTFE, which does not form a good transfer film. Subsurface cracks propagate easily through PTFE, releasing large flakes of wear debris that are thought to be several microns thick for normal use conditions. This type of wear does not facilitate transfer film formation for neat PTFE. The flakes create bumps that build and create a higher friction situation than would otherwise be present.

It is thought that composites according to the invention provide regions of the mechanically strong polymer (e.g. PEEK) reinforced by the transfer film forming polymer (e.g. PTFE) surrounded by pockets of transfer film forming polymer. The reinforced areas keep cracks localized, allowing only small amounts of transfer film forming polymer to be released at a time. This small debris is less easily removed and is forced into counterface features. This is believed to create the mechanically strong polymer reinforced transfer film forming polymer sliding on a thin, uniform transfer film forming polymer film.

This same mechanism also helps explain the low wear of the composite with respect to its constituents. The mechanically strong polymer reinforcement keeps cracks from propagating through the composite material, so the material would be more wear resistant than the transfer film forming polymer. For example, PEEK is regarded as a low wear engineering polymers, but suffers from a scuffing type of wear in its neat state. This is due to the large amount of frictional energy that must be absorbed by the material. This scuffing is abated in the composite material since the drawn out transfer film forming polymer film protects the PEEK and drastically lowers the frictional energy at the interface.

When embodied as a PEEK/PTFE composite, such composites have been found to provide COF similar to, or in some cases better than PTFE. The PEEK can be standard PEEK based on oxy-1,4-phenylene-oxy-1,4-phenylene-carbonyl-1 4-phenylene, or variants thereof.

The weight percent of the second polymer can be adjusted to accommodate a wide range of bearing requirements, such as low friction, low wear, high load capacity and low outgassing. The second polymer, such as PEEK, generally comprises at least 10 to 50 wt % of composites according to the invention, but can generally be up to about 90 wt % of such composites.

Industrially scalable methods for forming the composites according to the invention are now described relative to formation of a PEEK/PTFE composite. PTFE particles can be obtained commercially or synthesized in the laboratory. The particle size is preferably from about 1 μm to 20 μm. PEEK particles can also be obtained commercially, or again synthesized in the laboratory. The average size of the PEEK particles is preferably nanosize, such as on the order of 40 to 200 nm. However, the PEEK particles may be larger, such micron size up to about 10 μm, or smaller than this range.

The base layer, capping layer and transition layer can be formed by processes including compression molding or extrusion. The molding or extrusion step can comprise providing layers comprising a plurality of transfer film forming polymer particles and/or a plurality of strengthening phase polymer particles. The particles can be applied using separate nozzles for each polymer, where the ratio of polymer deposited is varied, such as in concentration steps, during formation of the transition region and then generally become a constant composition to form base layer and the low wear capping layer. A single extrusion or molding step is then preferably used at a temperature at or above the softening point of at least one, and preferably both, the first transfer film forming polymer and the second strengthening phase polymer to allow softening and mobilization of at least one of the plurality of transfer film forming polymer particles and the plurality of strengthening phase polymer particles, wherein a composite article is formed which provides a wear rate of <10⁻⁷ mm³/Nm. Heating is preferably sufficient to allow the capping layer to become integrated with the transition layer and the base polymer layer, such as through polymer bonding across the interfaces between the base layer/transition layer and the transition layer/capping layer.

In one embodiment, to form the capping layer, PTFE can be added to a mixing container and weighed using a precision analytical balance. The mixing container is preferably weighed continuously as the PEEK is then added to the PTFE, until the desired weight fraction of PEEK is obtained. The respective materials are generally unmixed after addition in a mixing chamber and consist mostly of agglomerations of PEEK and PTFE. A jet-mill apparatus or other type of suitable mixer can then be used to break up the agglomerated materials.

A jet mill uses high pressure air to accelerate the materials in a grinding chamber. The accelerated particles collide and break apart. The particles remain in the grinding chamber until they become small enough to move toward the outlet of the mill and into the collector. The milled material is preferably run through the jet-mill several additional times (e.g. two or three) to create a more uniform distribution.

After milling, the composite powder is disposed on transition layer particles which are disposed on base polymer particles. The transition layer process can follow a process analogous to the process described above relative to formation of capping layer, except the transition layer particles are preferably sprayed on the base layer particles to provide a graded concentration profile as described above. Compression molding is then preferably used. Compression molding is the most common method of forming thermosetting materials and involves simply squeezing a material into desired shape by heat and pressure to the material in the mold. Prior to using the mold, residual materials and oxides are generally sanded off the mold, and the mold is cleaned with hot sonicated water. The mold is then preferably dried with high velocity air from a compressor (filtered and dried), and filled with blended material.

The powder mixture is preferably compressed at about 20 to 100 MPa at room temperature for 15 min. The pressure is then preferably reduced to about 10 to 20 MPa and held constant while the sample is heated and then cooled. In one embodiment, the sample is heated, such as at a rate of 120° C./hour to reach a maximum temperature sufficient to allow softening and mobilization of the plurality of transfer film forming polymer particles and the plurality of strengthening phase polymer particles. For PTFE and PEEK, respectively, a minimum temperature of at least about 330° C. and a maximum temperature in the range of 360-380° C., is generally preferred. In this temperate range, both PEEK and PTFE are near or above their respective softening points, and thus have significant mobility. The maximum temperature can be held constant for several hours, such as three (3 hours), and can be decreased to room temperature at the same rate. Somewhat higher temperatures can also be used, provided decomposition does not occur. For example, regarding PTFE comprising composites, as the temperatures approach about 420° C. or more, the PTFE C—F bonds start fracturing and resulting material is generally not useful.

Besides compression molding, extrusion and injection molding can also be used. In another alternate method, composites according to the invention are formed using a porous network of a first polymer, such as the film forming polymer PTFE. The porous network is placed in a vacuum. An epoxy of the second polymer can be applied to the surface of porous network. The second polymer penetrate into the porosity of the porous network. Following a suitable cure step, the second polymer can solidify, thus forming a composite comprising a transfer film forming polymer network and a second polymer network integrated with the first polymer network. The resulting linkage between the second polymer is generally not as effective as compared to the linkage resulting from a molding process.

The superior tribological performance of composites according to the invention provides for a wide variety of applications for the invention. Improved products providable from the invention include, but are not limited to bushings, self lubricating bearings, bearing inserts, orthopaedic devices, and plastic gears.

Regarding orthopedic devices, for example, the base tibial tray which is currently made from metal parts such as mirror-like cobalt chrome, can be significantly improved and made less costly by being made integral to the bearing surface using polymer composites having graded interfaces according to the invention. The conventional metal tray and UHMWPE insert can be replaced by a single molded integral high strength polymer component formed from inventive composite articles having a high strength (e.g. PEEK) portion that is bonded to the bone, the article also including an integral solid lubricant surface (e.g. PTFE/PEEK). The inventive article preferably includes a transition layer composite interposed between solid lubricant surface and the base PEEK portion, the transition layer providing a compositional grading of PEEK and PTFE.

The solid lubricant surface of such an article according to the invention does not require the mirror-like surface finish that conventional UHMWPE inserts require. The invention thus is more economical because polishing of the cobalt chrome accounts for a very considerable portion of the cost of a replacement. These conventional highly polished surfaces also can be scratched in the body, increasing the wear rate of the UHMWPE insert with as more scratches develop. Unlike conventional replacements, composites according to the invention also provide a wide range of possible elastic properties depending on the volume fraction of the strengthening phase allowing the effective elastic modulus of an implant to be tunable. Optimization of the effective modulus across the surface can help keep wear uniform thus increasing the life components according to the invention.

The invention is also well suited for space applications, such as for improved space radar devices. Composites according to the invention will be highly stable in space environments. Significantly, unlike materials currently used for space radar, such as molybdenum disulfide, composites according to the invention do not measurably degrade during earth testing.

Regarding space applications, material outgassing and water absorption are of great concern in space bearing applications as they can result in instrument damage. ASTM E 595 is the test generally used as a standard for vacuum outgassing. This test measures total mass loss (TML), collected volatile condensable material (CVCM), and water vapor regained (WVR). Candidate space materials are generally rejected if TML>1.00% and CVCM>0.1%. A review of five random commercially available PEEK polymers indicates that the mean TML, CVCM and WVR reported were 0.39%, 0.01% and 0.1% respectively. The same review for PTFE yields an average TML, CVCM, and WVR of 0.034%, 0.00% and 0.02% respectively. PTFE performs much better than PEEK in vacuum, but both materials are regarded as good vacuum materials. All combinations of these polymers should meet the screening criteria. Water uptake is also an important consideration. Any water absorbed on earth will outgas once the material enters the low pressure environment. PTFE becomes saturated with 0.15% water uptake, and PEEK becomes saturated with 0.5% water uptake. These values are low compared to other polymers and are also generally acceptable for space applications.

The extreme temperature in space can cause melting and brittle fracture in some polymers. PTFE can be used in temperatures as high as 290° C. and as low as −200° C. PEEK can be operated as high as 150° C. to 300° C. (depending on grade) and as low as about −65° C. Accordingly, composites according to the invention, such as PTFE/PEEK composites are expected to meet fracture resistant for space applications in the temperature range specified for space applications of −40° C. to 100° C., or even through the broader military application temperature range specified (−55° C. to 125° C.).

Composite articles according to the invention can be compression molded into tubing. Following sectioning, the resulting tube sections can be used as bushings, such as around shafts. If the composite is formed as a solid rod, cutting can produce skived films which can provide sheets of the composite. Such sheets can be cut to a desired size, place on a part to be coated, including complex shaped parts, and then bonded together.

### EXAMPLES

The present invention is further illustrated by the following specific examples, which should not be construed as limiting the scope or content of the invention in any way.

### Example 1

### Formation of a PTFE/PEEK Composite

PTFE material was obtained from Dupont Corporation, Wilmington, Del. and particle sizes averaged 25 μm. PEEK particles were obtained from (Victrex PLC, UK) and believed to be on the order of 2 to 10 μm. The PTFE was added to a mixing container and weighed using a Mettler Toledo precision analytical balance. The mixing container was weighed continuously as PEEK was added to the PTFE, until the desired weight fraction of PEEK was obtained. These materials remained unmixed in the mixing container and consisted mostly of agglomerations. A Sturtevant jet-mill apparatus was used to break up these agglomerated materials.

After milling, the composite powder was compression molded. Prior to using the mold, residual materials and oxides are sanded off the mold, and the mold was cleaned with hot sonicated water for 15 minutes. The mold was then dried with high velocity air from a compressor (filtered and dried), and filled with blended material. A conventional heating press was used for compression molding.

The powder was compressed at 40 MPa (395 Atm) at room temperature for 15 min. The pressure was then reduced to 12 MPa (118 Atm) and held constant while the sample was heated and cooled. Four heaters were imbedded into heating platens on the top and bottom of the mold. A PID controller was used to obtain the desired temperature profile. The sample was heated at 120° C./hour up to 360° C. That temperature was held constant for 3 hours, and decreased to room temperature at the same rate. The molded samples were cylinders with a length of 1 inch and a diameter of 0.75 inch. A numerically controlled milling machine was used to cut the ¼ inch× 1/4 inch×½ inch pin from the molded puck.

### Example 2

### Tribological Testing

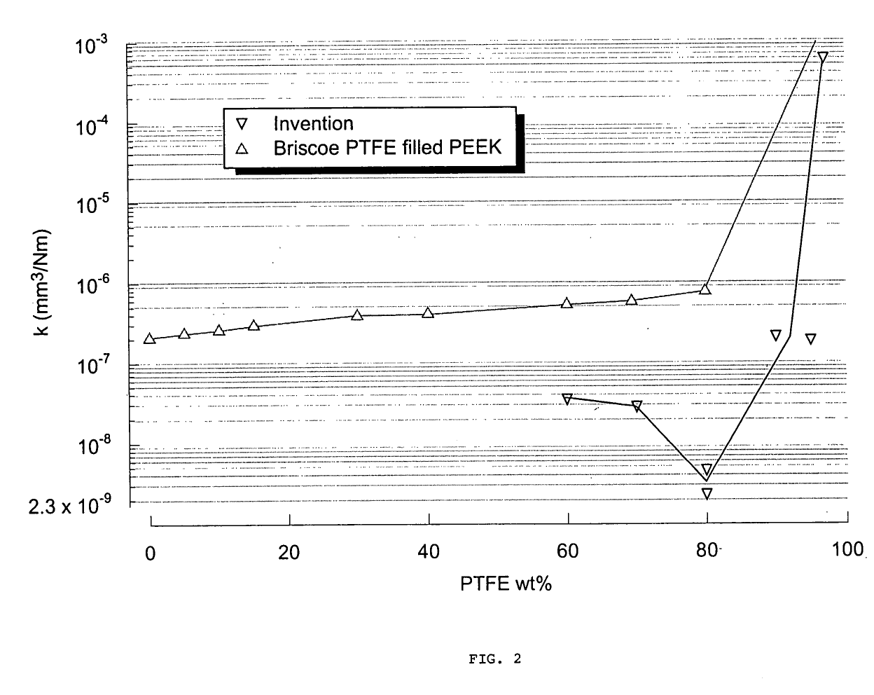

Data shown in FIGS. 2, 3, 4, and 5 were based on the following procedure:

The mold used produced 19 mm diameter×˜25 mm long cylinders. Samples measuring 6.4 mm×6.4 mm×12.7 mm were machined out of the interior of the compression molded cylinders using a laboratory numerically controlled milling machine. The finished samples were then measured and weighed and a density of the sample was calculated from these measurements. Only 1 sample was made from each compression-molded cylinder.

The counterfaces were plates made from 304 stainless steel measuring 38 mm×25.4 mm×3.4 mm. This material had a measured Rockwell B hardness of 87.3 kg/mm². Wear tests were performed on pins under dry sliding conditions against a 161 nm Rᵣₘₛ (with a standard deviation of 35 nm) lapped counterface. A linear reciprocating tribometer was used to test the composite material according to the invention. The counterface was mounted to a table that reciprocates 25 mm in each direction and was positioned with a stepper motor and ball screw system.

Prior to testing the counterfaces were washed in soap and water, cleaned with acetone, sonicated for ˜15 minutes in methanol, and then dried with a laboratory wipe. The nanocomposites were wiped down with methanol but were not washed or sonicated. The pin sample was mounted directly to a 6-channel load cell that couples to a linear actuator. Labview software was used to control two electro-pneumatic valves that pressurize the loading cylinder. Table position, pin displacement, friction force and normal force were recorded with the same software. The normal load applied to the pin was 250 N, and the sliding velocity was 50 mm/s. The entire apparatus was located inside a soft-walled clean room with conditioned laboratory air of relative humidity between 25-50%.

The mass of the pin was measured with a Mettler Toledo AX205 precision analytical balance that has a range of 220 g and a resolution of 10 μg. The mass loss of the sample (ΔM), the density of the material (ρ), the total test sliding distance (D) and the time averaged normal load (Fn) are used to calculate the wear rate (k) using the following equation:
k=ΔM/(ρ·Fn·D) Eqn. 1

The tests are interrupted periodically so the sample can be weighed. The uncertainty in each measurement was entered into a Monte Carlo simulation, which was used to calculate the average wear rate and the uncertainty in that wear rate.

FIG. 2 shows the wear rate (y-axis) of an exemplary PTFE/PEEK composite according to the invention as a function of PTFE wt % (x-axis; balance PEEK) as compared a PTFE filled PEEK composite according to Briscoe et al. The wear rate of the composite according to the invention shown in FIG. 2 is between 60 and 100 wt. % PTFE. When the wt. % PTFE is around 80%, the wear rate of the composite according to the invention is at least two orders of magnitude lower than the wear rate provided a 80 wt. % PTFE (20% PEEK) composite according to Briscoe et al. This data provides strong evidence of significant structural differences for polymer/polymer composites according to the invention, as compared to conventional filled polymer composites comprising a plurality of unconnected filler particles, such as disclosed by Briscoe et al.

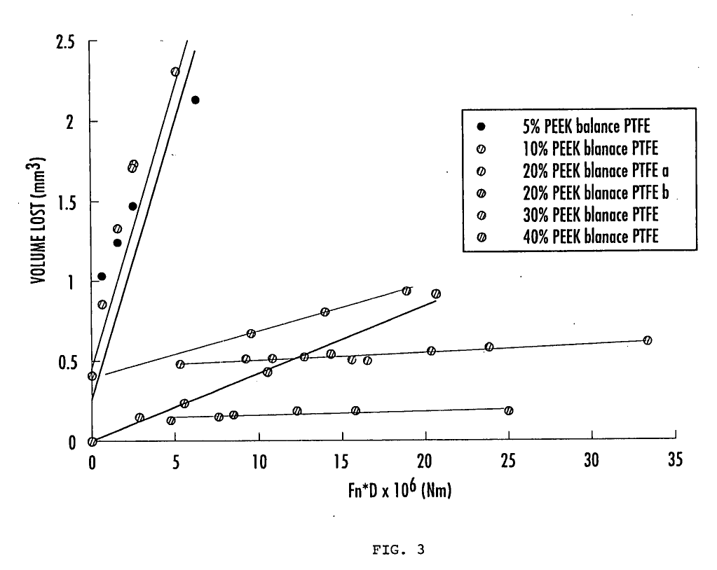

Interrupted test results from wear tests on a composite material according to the invention performed using 5, 10, 15, 20, 30 and 40 wt % PEEK (balance PTFE) compositions are shown in FIG. 3. Compositions referred to as 20(a) and 20(b) refer to the same 20 wt. % PEEK sample on the day of testing all the samples 20(a), and retesting results obtained about 5 days thereafter 20(b). When the PEEK wt. % is at least 20 wt. %, the composites showed exceptional and unexpected wear performance with almost no visual wear after two weeks of continuous sliding, and no measurable wear (>0.01 mg) on the Mettler precision balance for 1,000,000 cycles of sliding.

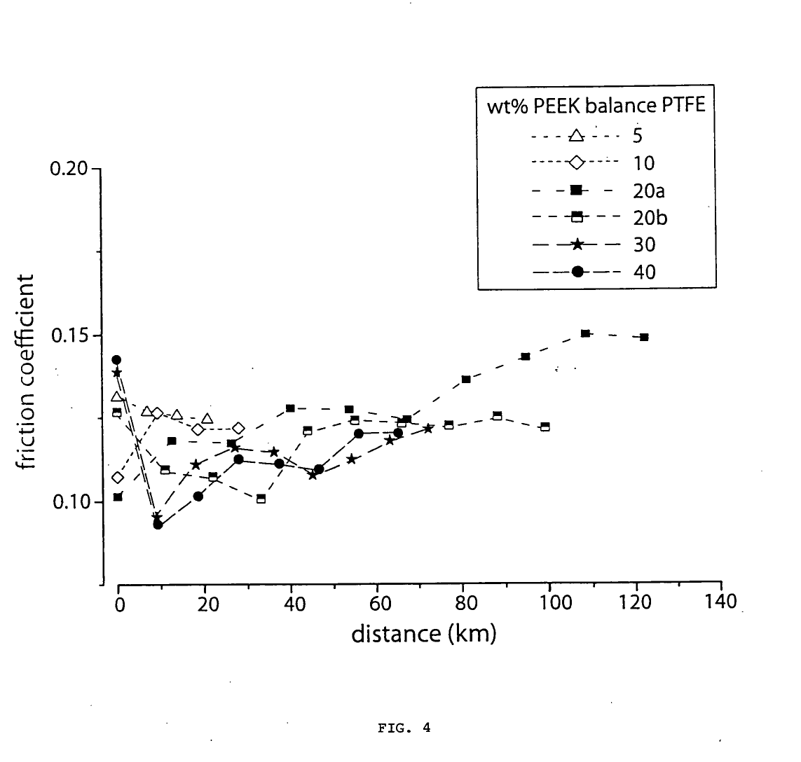

Friction has also be found to be very low for composites according to the invention. FIG. 4 shows instantaneous friction for each composite for the duration of two wear tests.

FIG. 4 shows average COF results obtained from the 5, 10, 15, 20(a) and (b), 30 and 40 wt % PEEK (balance PTFE) composites to be from about 0.1 to 0.13. For comparison, PTFE has had friction coefficients ranging from 0.11 to 0.15 under the same testing conditions. Thus, PEEK/PTFE composites according to the invention were found to provide a friction coefficient comparable to, or lower than PTFE.

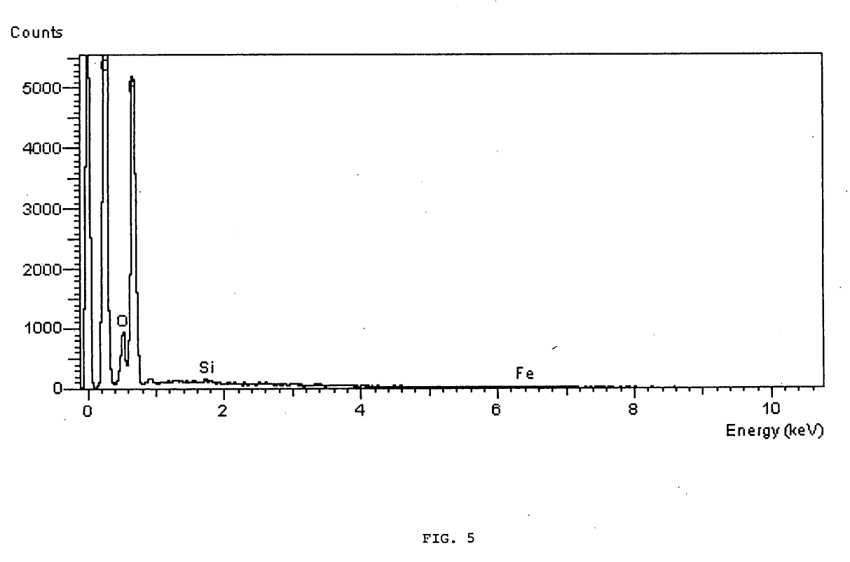

FIG. 5 shows EDS results of pin wear surface tests from a PEEK/PTFE composite according to the invention using a 20 wt % PEEK (balance PTFE) composition. The results demonstrate the material is non-abrasive as there is no Fe on the pin wear surface detected by the EDS measurement after 140 km of sliding. This result can be compared to PTFE which was found to wear out to the point it can no longer be tested after only 1 km of sliding.

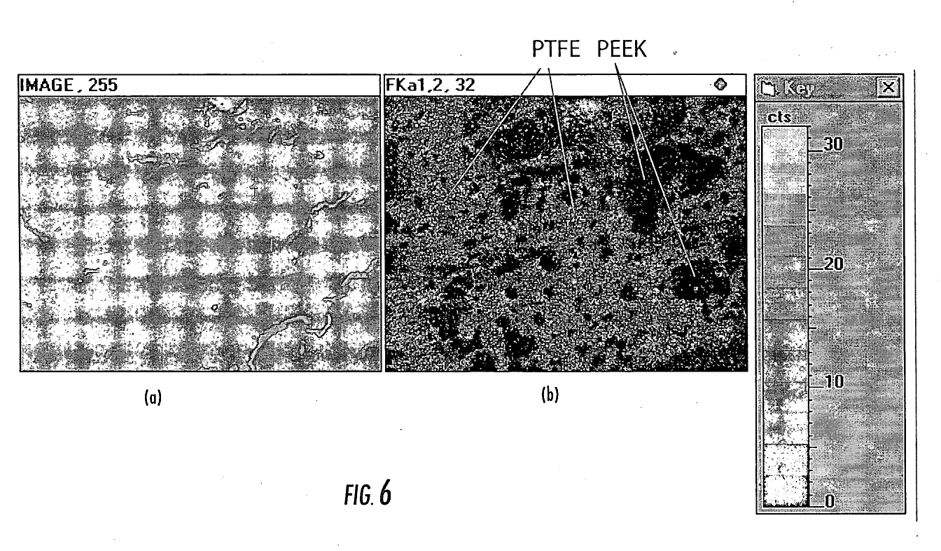

FIG. 6(a) is a scanned SEM and FIG. 6(b) a fluorine map of a PTFE/PEEK composite according to the invention. The light portions in each are PTFE regions.

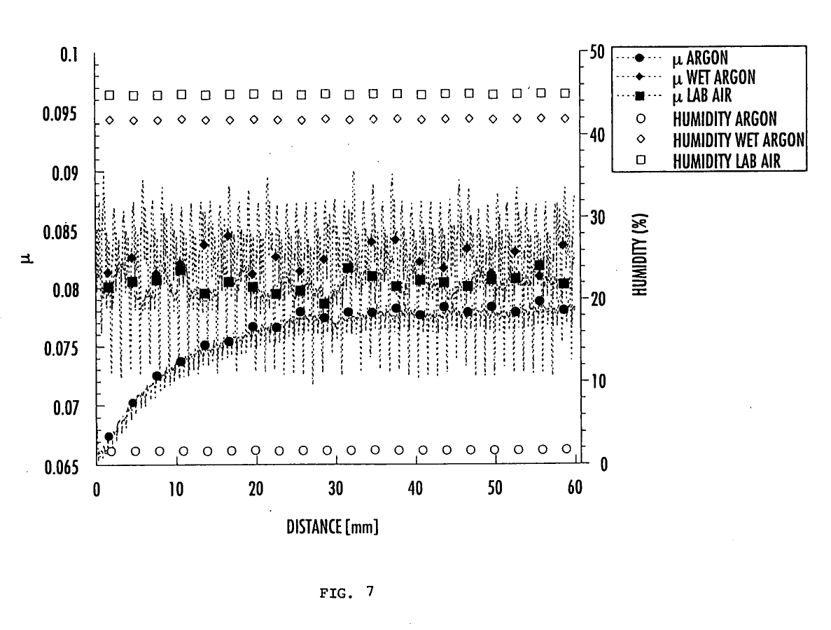

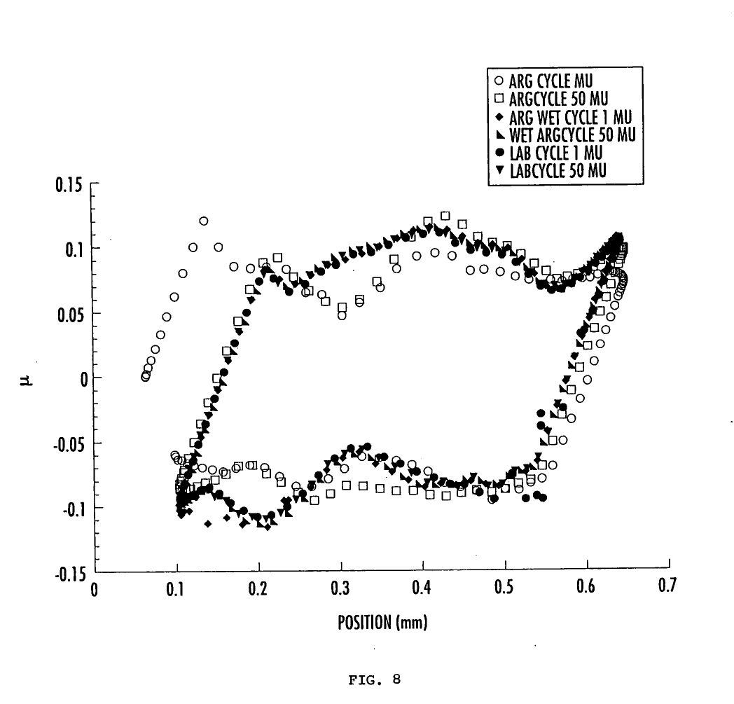

FIG. 7 shows friction coefficient vs. sliding distance results for a PEEK/PTFE composite according to the invention having 20 wt. % PEEK (balance PTFE) showing environmental insensitivity to humidity and air. Data shown in FIGS. 7 and 8 were obtained under environmentally controlled conditions. FIG. 7 shows that the composite is insensitive to water and other species notorious for dramatically changing the tribological characteristics of conventional advanced materials. The pin was a steel ball with a 1 mm radius, loaded to 0.45 N and was reciprocated at 5 mm/s on the composite. Max pressure was about 80 MPa.

FIG. 8 shows friction results for one reciprocation cycle for the beginning and end of each condition. The data shown in FIG. 8 demonstrates repeatability of the friction coefficient tests shown in FIG. 7.

### Example 3

### Formation of Multi-Layer Low Friction and Low Wear Polymer/Polymer Composites Having Compositionally Graded Interface Using Compression Molding

Powders of PTFE and PEEK were provided. A mold was then filled in discrete steps with powders of monotonically decreasing (or increasing) composition. The paragraph below describes a procedure used for a 1.25 inch cylindrical mold, which provides details regarding both composition and mass.

The bottom of the mold was first filled with 5000 mg 100 wt % 7C Teflon (PTFE). This is a sacrificial layer which is preferably machined off the finished article. PTFE is quite viscous at melt and prevents the solid PTFE lubricant from flowing out of the mold. Also, since PTFE is about twice as dense as PEEK, having high concentrations of PTFE on the bottom of the mold helps prevent instability during melt. The sacrificial layer was compressed to obtain a flat interface. Pressure for this step was in the range from 2000 psi to 20000 psi. Higher pressure is generally preferred.

2500 mg of a solid lubricant comprising composite layer was then added. The composition used was 50 wt % 450 XF PEEK and the remainder PTFE. Compression was then performed under conditions as described above. The grading itself in this Example was about half the mass of the solid lubricant layer. This rule of thumb however, depends on the desired composition differential. For example, the grading layer would be enlarged if the gradient were to go from material A to AB to B to BC to C. The amount of each of the successive layers then depends on the resolution of the material gradient available (in the limit that these layers go to zero mass as the gradient becomes continuous). In this example, PEEK content was increased in 10 wt % increments. This would make each layer about 250 mg. 250 mg of 60 wt % 450 XF PEEK remainder PTFE. were then added and than compressed. 250 mg of 70 wt % 450 XF PEEK remainder PTFE were added than compressed. 250 mg of 80 wt % 450 XF PEEK remainder PTFE were added then compressed. 250 mg of 90 wt % 450 XF PEEK remainder PTFE were added then compressed. 250 mg of 100 wt % 450 XF PEEK were added then compressed. An appropriate amount of 100 wt % 450 PF PEEK was added to supply material for the base layer to complete the article. Although not used, a sacrificial PTFE layer can be added to the top of the PEEK base layer if the PEEK flows out of the mold.

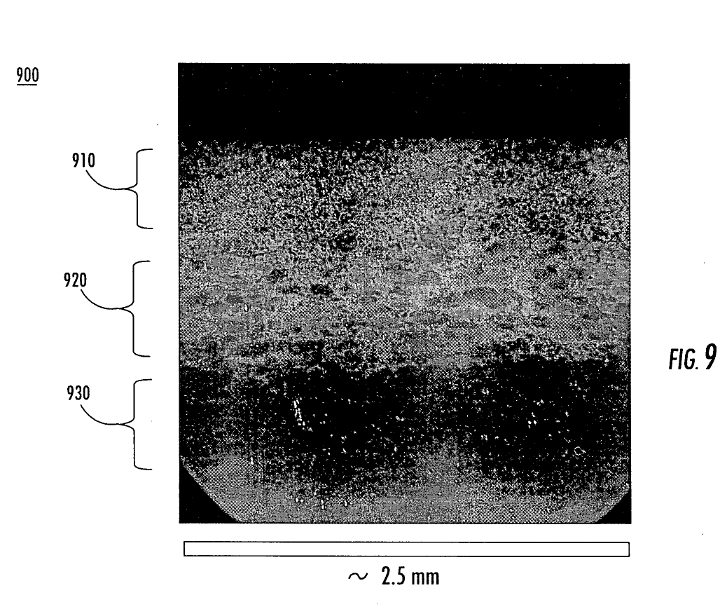

FIG. 9 shows a scanned optical micrograph image of a high strength multi-layer polymeric article 900 according to an embodiment of the invention showing a dimension scale. Article 900 includes a low wear solid lubricant surface 910 surface disposed on a graded interface layer 920, both being formed from PEEK/PTFE. The graded interface layer 920 can be clearly seen. The graded interface 920 is disposed on high strength component member 930 which was formed from all PEEK. The graded interface 920 provides a monotonically increasing PTFE concentration being at a minimum PTFE concentration at its interface with component member 930 and its maximum PTFE concentration at its interface with low wear solid lubricant surface 910 surface.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

We claim:

1. A high strength multi-layer polymeric article having a low wear surface, comprising:
a base polymer layer; and
a polymer composite capping layer disposed on said base polymer layer, said capping layer including a first polymer comprising a transfer film forming polymer, and a second polymer different from said first polymer for strengthening said polymer composite mixed with said first polymer, wherein said first polymer comprises at least 10 weight % of said capping layer, and
a transition layer composite interposed between said capping layer and said base polymer layer, said transition layer comprising said first and said second polymer, wherein at least a portion of said transition region provides a non-constant first or second polymer concentration, said article providing a wear rate of <10⁻⁷ mm³/Nm.

2. The article of claim 1, wherein said transition layer is compositionally graded.

3. The article of claim 1, wherein a thickness of said capping layer is less than 10 mm.

4. The article of claim 1, wherein said second polymer comprises between 15 wt % and 50% wt % of said composite capping layer.

5. The article of claim 1, wherein said first polymer comprises PTFE.

6. The article of claim 1, wherein said base polymer and said second polymer comprises a polyaryletherketone.

7. The article of claim 6, wherein said first polymer comprises PTFE.

8. The article of claim 7, wherein said composite comprises between 15 and 50% by weight of said second polymer.

9. The article of claim 1, wherein an average friction coefficient of said composite no more than 0.15.

10. The article of claim 9, wherein an average friction coefficient of said composite no more than 0.13.

11. A method of forming high performance composite materials having low wear surfaces, comprising the steps of:
providing a base polymer layer;
disposing a transition layer composite on said base polymer layer, said transition layer including a first polymer comprising a transfer film forming polymer, and a second polymer different from said first polymer for strengthening said polymer composite mixed with said first polymer, wherein at least a portion of said transition layer provides a non-constant first or second polymer concentration,
disposing a polymer composite capping layer on said base polymer layer, said capping layer comprising said first and said second polymer, wherein said first polymer comprises at least 10 weight % of said capping layer, and
heating said base polymer layer, said transition layer, and polymer capping layer to form said article, wherein after said heating a wear rate of said composite is <10⁻⁷ mm³/Nm.

12. The method of claim 11, wherein said transition layer is compositionally graded polymer.

13. The method of claim 11, wherein a thickness of said capping layer is less than 10 mm.

14. The method of claim 11, wherein said heating step comprises compression molding.

15. The method of claim 14, wherein said transition layer comprises a plurality of successive discrete sublayers, each of said sublayers having an increasing concentration of said first polymer as said transitional layer approaches said capping layer.

16. The method of claim 11, wherein said second polymer comprises between 15 wt % and 50 wt % of said composite.

17. The method of claim 11, wherein said first polymer comprises PTFE.

18. The method of claim 17, wherein said base polymer and said second polymer comprise PEEK.
